(19) United States
(12) Patent Application Publication
(10) Pub. No.: US 2007/0118507 A1
(43) Pub. Date: May 24, 2007

(54) Managing software configuration of a wireless device

(76) Inventor: John D. Bruner, South Barrington, IL (US)

Correspondence Address: MOTOROLA, INC., 1303 EAST ALGONQUIN ROAD, IL01/3RD, SCHAUMBURG, IL, 60196, US

(21) Appl. No.: 11/282,282

(22) Filed: Nov. 18, 2005

(51) Int. Cl. G06F 17/30

(52) U.S. Cl. 707/3; 713/168

(57) ABSTRACT

Various embodiments of the present invention provide methods used in a fixed portion of a wireless communication network for managing a software configuration of a wireless device (104) by a server (102). The method includes obtaining a list of current versions of software packages (312) present in the wireless device and calculating a list of software updates for the wireless device by comparing the list of current versions with a list of authorized versions of the software packages for the wireless device. The method also includes preparing a single software configuration update package based on the list of software updates and provisioning the software configuration update package to the wireless device. The single configuration update package is constructed to perform all updates to the software packages in the wireless device while avoiding updating files in the wireless device more than once.

### RELATED APPLICATION

This application is related to U.S. patent application Ser. No. 11/025,626, entitled “Apparatus And Method For Over The Air Software Repair”, filed on Dec. 29, 2004, and assigned to the assignee hereof.

### FIELD OF THE INVENTION

This invention relates in general to the field of software configuration management, and more specifically to software program version enhancements in wireless devices.

### BACKGROUND OF THE INVENTION

Large computing devices such as desktops and servers may implement multiple mechanisms for managing versions of software packages, each of which software package may include upgradable software components, for example, applications, components of applications, an operating system, or operating system components, and related configuration files and other data. Examples of such software packages include Microsoft® Word software, Apple® iTunes® software, and Adobe® Acrobat® Reader®. In some instances, a software package may comprise essentially only one executable program and any related configuration files and data related to the one program. An example of such a program is the battery handler program shipped by Dell Computers in some portables, named “battery.exe”. Management of the versions of these software packages may be required in a network for security purposes and to add functionalities to client devices in the network, and has been accomplished in many systems by using a package version update that can change a package version to an incrementally newer version by altering the components of the package. Updates to the package versions that are resident on one computing device may be aggregated into an accumulated update package, which may be individually provisioned to a client device. Each accumulated update package may include a plurality of package version updates. An accumulated update package may repeatedly update one or more target files of the software application or system component. (A target file in this document is a computer file that is altered by a software update). An accumulated update package may be given a version number, termed a package version. The client device maintains information regarding the inventory of previously installed package versions and versions of the software packages installed on the client device. However, this approach requires that the client device has a significant amount of non-volatile storage space and processing power to maintain and update its software packages. Hence, this approach is acceptable in case of desktops and servers, but may be difficult to implement in wireless devices, which have constrained memory space and processing power.

Wireless devices may vary in their capabilities due to the applications and software installed in their memory. Moreover, these wireless devices may have low memory or low processing power which may restrict their capabilities. Wireless device users frequently need access to information, which may not be readily available because of the low memory and the low processing power of the wireless devices and the limited bandwidth of wireless connections. As a result, the magnitude of transfer of data to and from the wireless device is limited.

Currently there are various methods for managing software configuration of wireless devices. In the simplest case, the device may contain a monolithic software image, for which a single version number is sufficient to describe the configuration. An update to this image consists of determining the current version number and delivering either a complete new monolithic image to replace it, or delivering a differential update. Commercially available solutions for generating updates to monolithic software images are available from multiple vendors, such as Bitfone, RedBend, etc.

In the more general case, the software on the managed device is modular, comprising the union of a set of versioned software packages. Each package comprises a set of objects including programs, configuration files, and other data. An update to this type of device entails determining the version numbers of all of the software packages, determining the availability of updated versions of these packages, and delivering this update set, called herein the accumulated update package, to the managed device. Often, some files on the device (especially configuration files) will be updated by more than one update in the accumulated update package. In order to accomplish these updates correctly, the device maintains a registry of information regarding software packages: their versions, contents, and inter-package dependences. This approach is achieved at the expense of the transmission time, computational resources, and on-device storage that is needed to manage software package state on the device.

### BRIEF DESCRIPTION OF FIGURES

In the accompanying figures, like reference numerals refer to identical or functionally similar elements throughout the separate views. These, together with the detailed description below, are incorporated in and form part of the specification, and serve to further illustrate the embodiments and explain various principles and advantages, in accordance with the present invention.

FIG. 1 illustrates an environment where various embodiments of the present invention can be practiced;

FIG. 2 illustrates a block diagram of a server, in accordance with an embodiment of the present invention;

FIG. 3 is a block diagram of a wireless device, in accordance with an embodiment of the present invention;

FIG. 4 is an exemplary flowchart illustrating a method for managing software configuration of a wireless device in a wireless communication network, in accordance with an embodiment of the present invention; and

FIG. 5 is an exemplary flowchart illustrating a method for managing software configuration of a wireless device, in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements, to help in improving an understanding of embodiments of the present invention.

### DETAILED DESCRIPTION

Before describing in detail the particular method and system for managing software configuration of a wireless device in accordance with the present invention, it should be observed that the present invention resides primarily in combinations of method steps and system components related to generation of a software configuration update package for managing software configuration of the wireless device. Accordingly, the system components and method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

In this document, relational terms such as first and second, and the like may be used solely to distinguish one entity or action from another entity or action without necessarily requiring or implying any actual such relationship or order between such entities or actions. The terms ‘comprises,’ ‘comprising,’ or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by ‘comprises . . . a’ does not, without more constraints, preclude the existence of additional identical elements in the process, method, article, or apparatus that comprises the element.

The present invention describes a method used in a fixed portion of a wireless communication network for managing a software configuration of a wireless device in the wireless communication network. The method includes obtaining a list of current versions of software packages present in the wireless device, calculating a list of software updates for the wireless device by comparing the list of current program versions of the software with a list of authorized program versions of the software for the wireless device, and preparing a software configuration update package based on the list of software updates. The software configuration update package is constructed so that when the software configuration update package is applied to the wireless device, no substantial changes are made to any target file of the software packages more than once. In some embodiments, no substantial changes means that no changes are made more than once to at least 95% of the target files that are changed by the software configuration update package. In some embodiments, no substantial changes means that an average percentage of the bytes of code changed in all of the files of a software package is less than 5% In some embodiments, no changes are made more than once to any of the target files that are changed by the software configuration update package. The method further includes provisioning the software configuration update package to the wireless device. Each software package comprises one or more target files, which are files of software package that are to be updated by the software configuration update package. In some embodiments, the list of software updates for the wireless device includes at least one instance of two updates that each alter the same file in the software package. In other words, in these embodiments, there is at least one file that is modified by two updates of the list of updates, but is modified only once by the software update configuration package.

In some embodiments, one or more of the software packages includes only one file that is altered by the software update configuration package.

The present invention also describes a method used in a wireless device. The method includes receiving a query from a server for a list of current versions of the software packages present in the wireless device and sending the list of current program versions to the server in response to the query. The method further includes determining on the server, from the list of current versions of software packages, a set of authorized software updates and creating on the server a software configuration update package from the set of authorized software updates. The method further includes receiving a software configuration update package provisioned by the server, and applying changes in response to the software configuration update package. While applying changes in response to the software configuration update package, no substantial changes are made to any target file of the current software more than once. The meaning of no substantial changes may have the same definitions as given above. In some embodiments, no changes are made more than once to any of the target files that are changed by the software configuration update package.

Moreover, the present invention describes a server for managing a software configuration of one or more wireless devices in a wireless communication network. The server includes a query unit and a processing unit. The query unit queries the one or more wireless devices for a list of current versions of software packages resident on the wireless device. The processing unit generates a software configuration update package based on the list of current versions. The server further includes a service unit, which provisions the software configuration update package to the one or more wireless devices.

The present invention also describes a wireless device, which includes a storage unit and a transceiver. The storage unit stores in a file a list of current versions of substantially all updateable.software packages present in the wireless device. The transceiver transmits the list of current program versions to the server. The wireless device may further include a processor, which is capable of installing a the software configuration update package obtained from the server. “Substantially all updateable software packages” excludes software packages or portions thereof that have been identified as not being updatable due to reasons such as a high security level, or lack of digital rights that would allow alteration according to licensing or purchase agreements.

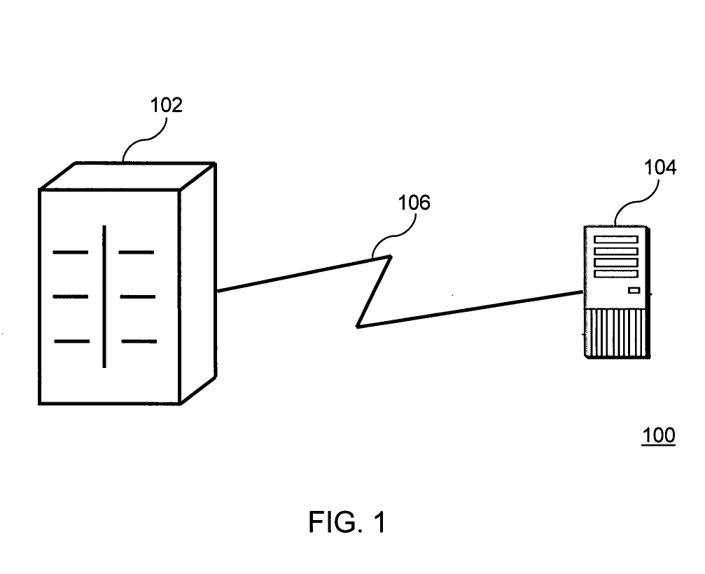

FIG. 1 illustrates an environment 100 in which various embodiments of the present invention can be practiced. The environment 100 may be a portion of a wireless communication network. The environment 100 includes a server 102 and a wireless device 104 connected by a wireless communication link 106. The server 102 interacts with the wireless device 104 to manage software configuration in the wireless device 104. The wireless device 104 may be an electronic device used for the purpose of communication. Examples of the wireless device 104 include, but are not limited to, mobile phones, Personal Digital Assistants (PDAs), and the like. Though the environment 100 is shown to include only the wireless device 104, however, the environment 100 may include a plurality of wireless devices. When the environment 100 is a portion of a wireless communication system, a fixed network of the wireless communication system may comprise a plurality of servers that includes the server 102. In this situation, functions that are described herein as being performed by the server 102 may be actually be performed by the server 102 operating in collaboration with others of the plurality of servers. For example, another of the plurality of servers may have a database that the server 102 accesses to perform a function described herein.

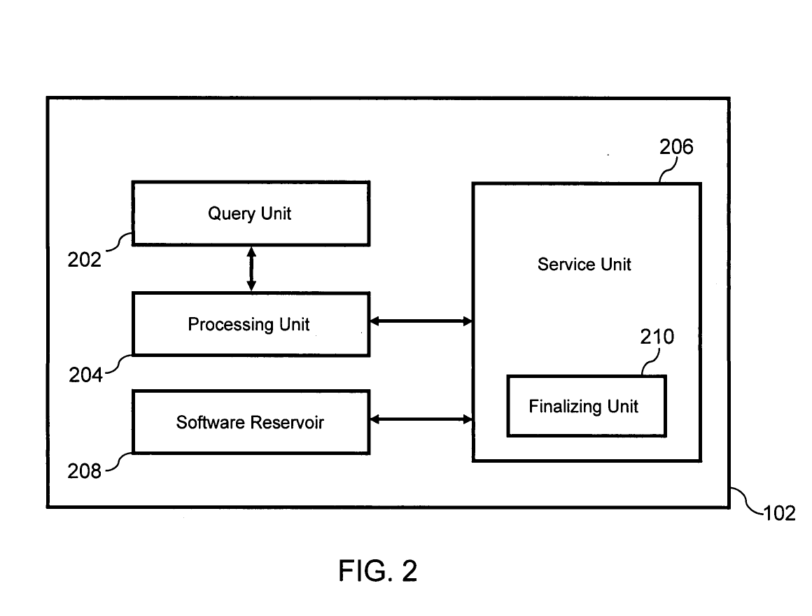

FIG. 2 illustrates a block diagram of the server 102, in accordance with an embodiment of the present invention. The server 102 includes a query unit 202, a processing unit 204, and a service unit 206. The query unit 202 makes a query for a list of current versions of software packages that are present on one or more wireless devices. In some embodiments, the list may be one that includes substantially all updateable software packages resident in the wireless device. Non-updateable software packages may exclude those for which licensing rights are not expected to be made available, or which are meant to be protected from changing under normal circumstances (such as programs or data that needs extra security and are changed only by other more complex means). In some embodiments, the list includes only those software packages that can be updated by the server. A version of a software package is the information needed to uniquely identify the contents of the software package, which may be a software application, a system component, a servlet, and the like, that are present in the one or more wireless devices, and for which updates may be available from a distributor of the software.

In some embodiments, one or more of the software packages may include only one executable file, and/or the software package may be more commonly referred to as a software program.

The processing unit 204 can generate a software configuration update package for a wireless device based on the list of current versions present on one of the one or more wireless devices and a list of software packages authorized for each wireless device. The processing unit 204 is operatively coupled to the service unit 206. The service unit 206 provisions the software configuration update package to the wireless device by causing it to be transmitted to the wireless device. The server 102 also includes a software reservoir 208. The software reservoir 208 stores versions of software packages and software updates that can be provisioned to the wireless device. The service unit 206 further includes a finalizing unit 210, which sends a new list of versions of software packages that reflect the software configuration update packages provisioned to the one or more wireless devices.

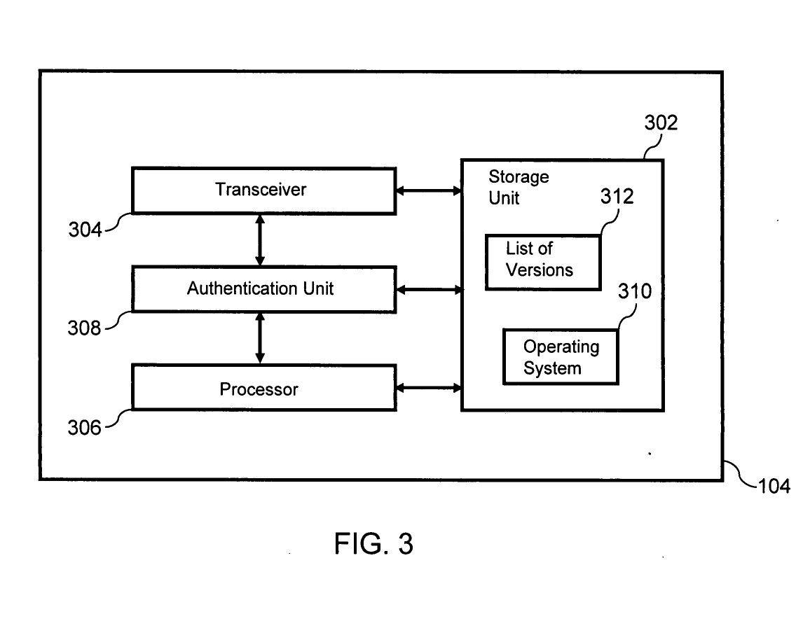

FIG. 3 illustrates a block diagram of the wireless device 104, in accordance with an embodiment of the present invention. The wireless device 104 includes a storage unit 302, a transceiver 304, and a processor 306. The storage unit 302 may store a list of current versions of the software packages installed in the wireless device 104. As noted above, in some embodiments, the list may comprise substantially all updateable software packages in the wireless device. The storage unit 302 is operatively coupled to the transceiver 304 and the processor 306. The wireless device 104 can receive a query for the list of current versions from the server 102 through the transceiver 304. The wireless device 104 can then provide the list of current versions to the server 102 through the transceiver 304. In an embodiment of the present invention, the wireless device 104 enables the server 102 to access the list of current versions. The processor 306 also installs the software configuration update package, which may accomplish the same changes to the software packages that are made by the software updates in the list of software updates determined from the list of current versions and authorized versions. In other words, applying the changes achieves the same results as would be achieved by applying the set of software updates that are in the list of software updates

The wireless device 104 also includes an authentication unit 308. The authentication unit 308 may check the authenticity of the server 102 making the query for the list of current versions of software packages in the wireless device 104. In some embodiments of the present invention, the storage unit 302 is configured to support an operating system 310, and the processor 306 is configured to execute the operating system 310. The operating system 310 may be, for example, a Linux operating system.

The storage unit 302 contains a list of current software package (and/or program) versions 312 that can be retrieved and updated by the server 102.

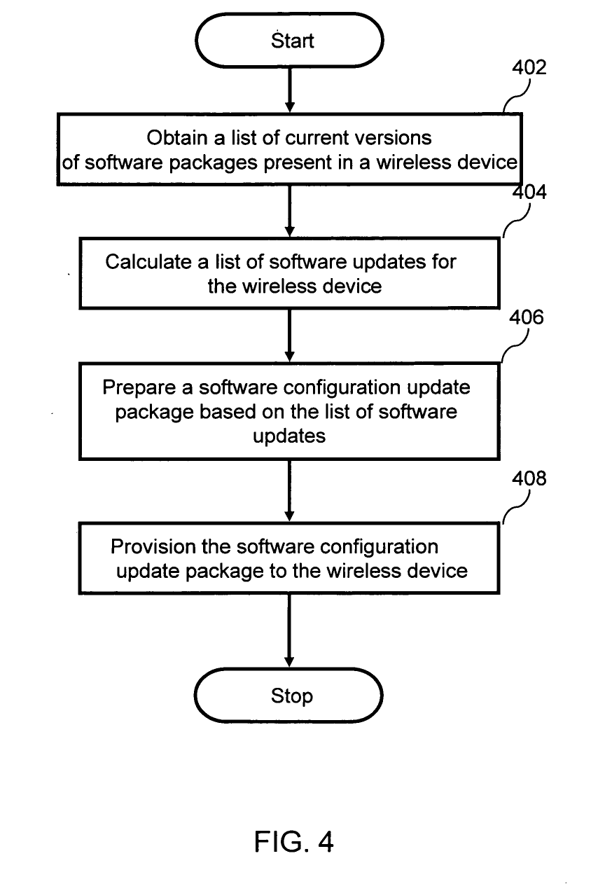

FIG. 4 is a flowchart illustrating a method used in a fixed portion of a wireless communication network for managing software configuration of a wireless device, in accordance with an embodiment of the present invention. At step 402, a server obtains a list of current versions of software packages present in the wireless device. For example, the query unit 202 of the server 102 makes a query for the list of current versions of software packages present on the wireless device 104. This query may take any number of forms. In one possible implementation, the query unit 202 queries the wireless device 104 using the Open Mobile Alliance Device Management protocol (OMA DM). The server obtains the list of current versions of software packages sent by the wireless device. For example, the processing unit 204 of the server 102 obtains the list of current versions sent by the wireless device 104. At step 404, the server calculates a list of software updates for the wireless device. For example, the processing unit 204 of the server 102 compares the list of current versions of the software packages with a list of authorized versions of the software packages for the wireless device 104, to generate a list of software updates for the wireless device 104. The list of authorized versions may be obtained from another server in the fixed portion of the wireless communication system. An authorized version is the information needed to uniquely identify the contents of a software package, that is present in the server.

At step 406, the server prepares a single software configuration update package, based on the list of software updates for the wireless device. For example, the processing unit 204 of the server 102 constructs the software configuration update package from the software reservoir 208. The software configuration update package is constructed from a collection of software package update files, or software updates. Each of the software package update files comprises one of a version update, a version upgrade, or a new file for a plurality of related programs, configuration files, and other related data objects. Examples of version updates include, but are not limited to repairs, packages, bug fixes, security fixes and service packs. The version update may involve adding new features. The version update may also involve version updates for the currently installed software packages. The processing unit 204 of the server 102 analyzes and reconstructs the collection of update files into the software configuration package so that when the software configuration update package is applied to the wireless device, no substantial changes are made to any target file of the software packages more than once, wherein in some embodiments, substantial has the meaning provided above. In some embodiments, no changes are made to any target file of the current software of the wireless device.

At step 408, the server 102 provisions the software configuration update package to the wireless device. Provisioning the software configuration update package can include providing instructions for installing the software configuration update package. The server 102 may also send a new list of versions of the software packages that reflects the changes made by the software configuration update package to the wireless device 104. For example, the finalizing unit 210 of the server 102 may send a new list of versions of the software packages to the wireless device 104. In one implementation, the server 102 provisions the software configuration update package and the new list of versions of the software packages using the OMA DM protocol.

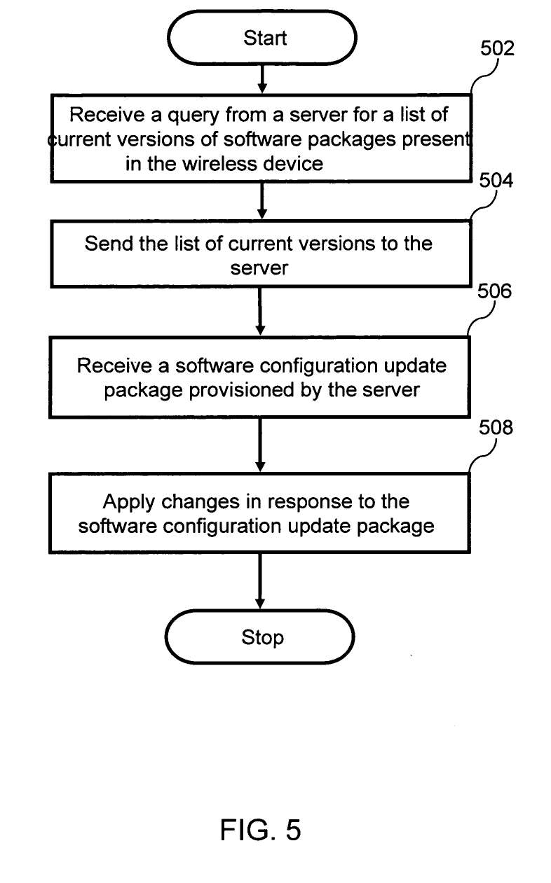

FIG. 5 is a flowchart illustrating a method for managing a software configuration in a wireless device 104, in accordance with an embodiment of the present invention. At step 502, the wireless device 104 receives a query from a server for a list of current versions of software packages present in the wireless device 104. For example, the transceiver 304 of the wireless device 104 receives a query from the server 102 for the list of current versions present on the wireless device 104. In one implementation, this query may be performed using the Open Mobile Alliance Device Management protocol (OMA DM). The wireless device 104 may check the authenticity of the server that makes the query. For example, the authentication unit 308 of the wireless device 104 that is operatively coupled to the transceiver 304 may check the authenticity of the server 102 that makes the query before proceeding to step 504. At step 504, the wireless device 104 sends the list of current versions to the server 102. For example, the wireless device 104 sends the list of current versions to the server 102 through the transceiver 304. In an embodiment of the present invention, the server 102 may store the list of current versions locally so that the server need not access the wireless device to obtain this list. In another embodiment, the list of current versions may be stored in another server that the server 102 has permission to access.

At step 506, the wireless device receives a software configuration update package provisioned by the server. For example, the wireless device 104 receives the software configuration update package provisioned by the server 102. At step 508, the wireless device applies changes in response to the software configuration update package provisioned by the server. The wireless device installs the software configuration update package. For example, the wireless device 104 applies changes in response to the software configuration update package provisioned by the server 102. The processor 306 of the wireless device 104 installs the software configuration update package. In some embodiments, no substantial changes are made to target files more than once, wherein the meaning of no substantial changes is as defined above. In some embodiments, while installing the software configuration update package, target files of the current software packages are modified only once, rather than, for example, modifying many target files a plurality of times to implement sequential software updates for one software application, as is done by conventional software updating packages.

As described above, various embodiments of the present invention enable easier creation and delivery of new and updated program versions of software to one or more wireless devices. The method provided by the present invention includes storing a list of current program versions of software with the wireless device and maintaining all the details about the software with the server. The method also includes splitting a set of installation packages that are to be applied to a wireless device on the server side, so that only one software configuration update package is sent to the wireless device. If there are successive updates to be made to a given target file of the current software, these updates are cumulatively applied on the server side. Only one repair/patch is downloaded and installed by the wireless device and changes to the given target file of the current software on the wireless device are applied only once. Consequently, the wireless device need not know about the format of the software configuration update package that is provisioned by the server to the wireless device.

It will be appreciated the modules described herein may be comprised of one or more conventional processors and unique stored program instructions that control the one or more processors to implement, in conjunction with certain non-processor circuits, some, most, or all of the functions of the modules described herein. The non-processor circuits may include, but are not limited to, a radio receiver, a radio transmitter, signal drivers, clock circuits, power source circuits, and user input devices. As such, these functions may be interpreted as steps of a method to perform {accessing of a communication system}. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein.

It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method used in a fixed network portion of a wireless communication network for managing a software configuration of a wireless device used in the wireless communication network, the method comprising:
obtaining a list of current versions of software packages present in the wireless device, wherein each software package comprises one or more target files;
calculating a list of software updates for the wireless device by comparing the list of current versions of software packages with a list of authorized versions of software packages for the wireless device;
preparing a software configuration update package based on the list of software updates, wherein the software configuration update package is constructed so that when the software configuration update package is applied to the wireless device, no substantial changes are made to any target file of the software packages more than once; and
provisioning the software configuration update package to the wireless device.

2. The method according to claim 1, wherein obtaining the list of current versions of software packages comprises making a query to the wireless device for the list of current versions of software packages, which is present in the wireless device.

3. The method according to claim 2, wherein making the query is performed using an Open Mobile Alliance Device Management protocol.

4. The method according to claim 1, wherein the list of software updates comprises a list of a plurality of update files, each of the plurality of update files being one of a version update, a version upgrade, or a new application.

5. The method according to claim 1, further comprising sending a new list of software package versions reflecting the software configuration update package to the wireless device.

6. The method according to claim 1, wherein the sending of the new list of program package versions is performed using the Open Mobile Alliance Device Management protocol.

7. The method according to claim 1, wherein the software update configuration package is transmitted to the device using the Open Mobile Alliance Device Management Protocol.

8. The method according to claim 1, wherein the list of current versions of software packages present in the wireless device is stored and queried locally on the server.

9. The method according to claim 1, wherein the list of software updates for the wireless device includes at least one instance of two updates that each alter the same file in the software package.

10. The method according to claim 1, wherein one or more of the software packages includes only one file that is altered by the software update configuration package.

11. The method according to claim 1, wherein one or more of the software packages includes only one executable file.

12. The method according to claim 1, wherein no substantial changes means one of:
no changes are made more than once to at least 95% of the target files that are changed by the software configuration update package; and
an average percentage of the bytes of code changed in all of the files of changed by the software update configuration package is less than 5%

13. A method for managing a software configuration of a wireless device, the method comprising:
receiving a query at the wireless device from a server for a list of current versions of software packages present on the wireless device;
sending the list of current versions from the wireless device to the server;
determining on the server, from the list of current versions of software packages, a set of authorized software updates;
creating on the server a software configuration update package from the set of authorized software updates, such that no substantial changes will be made to any target file on the wireless device more than once;
receiving at the wireless device the software configuration update package provisioned by the server; and
applying changes to target files of the applications in the wireless device in response to the software configuration update package.

14. The method according to claim 13, further comprising authenticating an identity of the server.

15. The method according to claim 13, further comprising creating a list on the server of updated versions of the software packages resident on the wireless device.

16. The method according to claim 13, further comprising receiving a new list of updated versions of the software packages at the wireless device reflecting the results of applying the changes to the target files.

17. The method according to claim 13, wherein applying the changes achieves the same results as would be achieved by applying the set of software updates that are in the list of software updates.

18. A wireless device comprising:
a storage unit that stores a list of current versions software packages in a data file; and
a transceiver configured to wirelessly transmit the list of current versions to a server.

19. The wireless device according to claim 18 further comprising a processor operatively coupled to the storage unit and the transceiver, the processor capable of installing a software configuration update package provisioned by the server, wherein the software configuration update package is generated based on the list of current versions of software packages, such that no substantial changes are made to any target file of the software packages more than once by the processor.

20. The wireless device according to claim 18 further comprising an authentication unit, wherein the authentication unit checks the authenticity of the server making a query for obtaining the list of current versions of software packages.

21. The wireless device according to claim 18, wherein the list of current versions of software packages comprises substantially all updateable software packages resident in the wireless device.
